(19) United States
(12) Patent Application Publication
(10) Pub. No.: US 2017/0326572 A1
(43) Pub. Date: Nov. 16, 2017

(54) REMOTELY PROGRAMMABLE ELECTRONIC DOG BARK ACTIVATED LAWN SPRINKLER SYSTEM AND METHOD FOR DISPERSING URINE LOCATIONS AND SIMULTANEOUSLY DILUTING CONCENTRATED AREAS OF DOG URINE ON A LAWN

(71) Applicant: TALLGRASS, LLC, Manchester, IA (US)

(72) Inventors: Leon Anthony Goerdt, Manchester, IA (US); Jennifer Lynn Goerdt, Cedar Rapids, IA (US); Jesse James Hahn, Cedar Rapids, IA (US)

(21) Appl. No.: 15/587,722

(22) Filed: May 5, 2017

Related U.S. Application Data
(60) Provisional application No. 62/336,167, filed on May 13, 2016.

(51) Int. Cl. B05B 15/10; A01K 15/02; A01G 27/00

(52) U.S. Cl. CPC B05B 15/10; A01G 27/003; A01K 15/021

(57) ABSTRACT

A multi-purpose system is disclosed which utilizes a lawn sprinkler in the shape of a fire hydrant to provide a stimulus to a dog. A remotely programmable portable water sprinkler is provided, which can be programmed to run for a period of time for normal watering of a lawn, and it can be programmed to trigger and spray when a series of dog barks are detected. This spraying of water is intended to be a stimulus to the dog.

### FIELD OF THE INVENTION

The present invention generally relates to systems which may improve lawn quality by reducing areas of highly concentrated urine on a lawn. More specifically, the invention is intended to be used for spraying water at a dog or group of dogs where the system is not worn on the dog.

### BACKGROUND OF THE INVENTION

In the past, it is well known that areas of high urine concentration on a lawn can kill grass. Additionally, it is well known that some dogs tend to concentrate their urination in specific areas. These can be areas where the dog, for whatever reason, tends to spend more time; they can be areas where the dogs detect odors of other dog's urine or merely areas of habitual urination. It is difficult to detect in advance when a dog is going to urinate.

In the past, there have been collar-mounted bark-activated spray mechanisms that have been known for spraying water at a dog when barking is detected.

While these systems have enjoyed some success in the past, for varied purposes and reasons, however, the dog-worn spray devices typically are effective on only one dog at a time, making them more expensive per dog, especially when multiple dogs are present. And they do not spray enough water on the lawn to significantly dilute high concentrations of urine in the lawn.

Consequently, there are few systems for reducing areas of high concentration of dog urine in a lawn.

### SUMMARY OF THE INVENTION

It is an object of the present invention to provide an easily implemented system for spraying, when a dog is detected as barking, a significant amount of water in a predetermined zone, around a sprinkler.

It is a feature of the present invention to utilize a garden hose connection with a water system.

It is another feature of the present invention to provide for smart phone app programmability of the system.

It is another feature of the multi-purpose system of the present invention to be programmable to become a non-dog activated lawn sprinkler.

It is an advantage of the present invention to provide for spraying water in a predetermined area of a lawn when a dog is detected through bark detection.

The present invention is an apparatus and method for efficiently and cost effectively providing stimuli to a dog that is present in a predetermined area. The present invention is carried out in a “collar worn-less” system, in a sense that water is sprayed, as a stimuli at a dog, without the need for the dog to wear any apparatus.

Accordingly, the present invention is a method of encouraging a barking dog to move to a different location and thereby reducing dog urine concentrations in a lawn comprising the steps of:
providing a first remotely programmable electronic lawn sprinkler, having:
   a first portable cover 102, 104, sized and configured to be carried by a person and placed at variable locations;
   a first garden hose female coupler 110 disposed on a first back side of said first cover;
   a first housing sound transmission zone 126, located at a first front side of said first cover;
   a first sprinkler head 108, disposed on said first cover;
   a first electronic water control valve 118 disposed inside said first cover;
   a first microphone 122, disposed inside said first cover and disposed in registration with said first housing sound transmission zone 126, so as to directionally discriminate from detection by said first microphone, sound waves, which are more obliquely incident on a first surface of said first cover, immediately around said first housing sound inlet port, than are sound waves which are more orthogonal to said first surface of said first cover immediately around said first housing sound inlet port;
   a first battery 112 disposed inside said first cover; and
   a first circuit board 120 disposed inside said first cover which has:
      a first microcontroller section 3 configured to: receive electric power from said first first battery; receive electronic signals originating from said first microphone which are representative of sound originating from outside said first cover; and generate first electronic control signals for use in control of said first electronic water control valve; and
      a first section 5 configured to receive, from a remote appliance, wireless signals for remote programming of said first microcontroller section so as to set:
         a. a sensitivity characteristic representative of a minimum threshold under which sound will not be recognized as a sound event;
         b. a minimum number of sound events needed to trigger generation of one of said electronic control signals;
         c. receiving from said remote appliance said wireless signals; and
         d. configuring said first microcontroller section to be responsive to said wireless signals, by changing:
         a. a sensitivity characteristic representative of a minimum threshold under which sound will not be recognized as a sound event;
         b. a minimum number of sound events needed to trigger generation of one of said electronic control signals;
         c. said first front side and said first back side being disposed on opposite sides of said first cover, so that a direction of water inlet into said first cover is substantially opposite of a direction of least discrimination of sound waves incident upon said first microphone;
         d. receiving electronic signals from said first microphone representative of said minimum number of sound events; and
         e. generating an electronic control signal for said first electronic water control valve commanding the valve to open and to spray water out of said sprinkler head, in response to said electronic signals from said first microphone representative of said minimum number of sound events.

Additionally, the present invention is a system for reducing dog urine concentrations in a lawn comprising:

a first remotely programmable electronic lawn sprinkler, having:
a first portable cover 102, 104, sized and configured to be carried by a person and placed at variable locations;
a first garden hose female coupler 110 disposed on a first back side of said first cover;
a first housing sound transmission zone 126, located at a first front side of said first cover;
a first sprinkler head 108, disposed on said first cover;
a first electronic water control valve 118 disposed inside said first cover;
a first microphone 122, disposed inside said first cover and disposed in registration with said first housing sound transmission zone 126, so as to directionally discriminate from detection by said first microphone, sound waves which are more obliquely incident on a first surface of said first cover, immediately around said first housing sound inlet port, than are sound waves which are more orthogonal to said first surface of said first cover immediately around said first housing sound inlet port;
a first battery 112 disposed inside said first cover; and
a first circuit board 120 disposed inside said first cover which has:
   a first microcontroller section 3 configured to: receive electric power from said first battery, receive electronic signals originating from said first microphone, which are representative of sound originating from outside said first cover, and generate first electronic control signals for use in control of said first electronic water control valve; and
   a first section 5 configured to receive, from a remote appliance, wireless signals for remote programming of said first microcontroller section so as to set:
      a. a sensitivity characteristic representative of a minimum threshold under which sound will not be recognized as a sound event;
      b. a minimum number of sound events needed to trigger generation of one of said electronic control signals; and
      c. said first microcontroller section being configured to be responsive to said wireless signals, by changing:
         a. a sensitivity characteristic representative of a minimum threshold under which sound will not be recognized as a sound event;
         b. a minimum number of sound events needed to trigger generation of one of said electronic control signals; and
         c. said first front side and said first back side being disposed on opposite sides of said first cover, so that a direction of water inlet into said first cover is substantially opposite of a direction of least discrimination of sound waves incident upon said first microphone.

### BRIEF DESCRIPTION OF THE DRAWINGS

The invention may be more fully understood by reading the foregoing description of the preferred embodiments of the invention, in conjunction with the appended drawing wherein:

FIG. 1 is an exploded perspective view of the present invention.

FIG. 2 is a partially assembled view of components of FIG. 1.

FIG. 3 is a detailed schematic diagram of a circuit board of the present invention.

FIG. 4 is a simplified block diagram of a directionally selectively system of the present invention.

FIG. 5 is a screen shot of a smart phone of the present invention.

### DETAILED DESCRIPTION

Although described in detail below, with particular reference to reducing high concentrations of urine in a lawn, the present invention is not intended to be limited to such applications. The present invention could be applied to spraying water on flower beds, patios, and for spraying water in response to dog bark detection for other purposes as well.

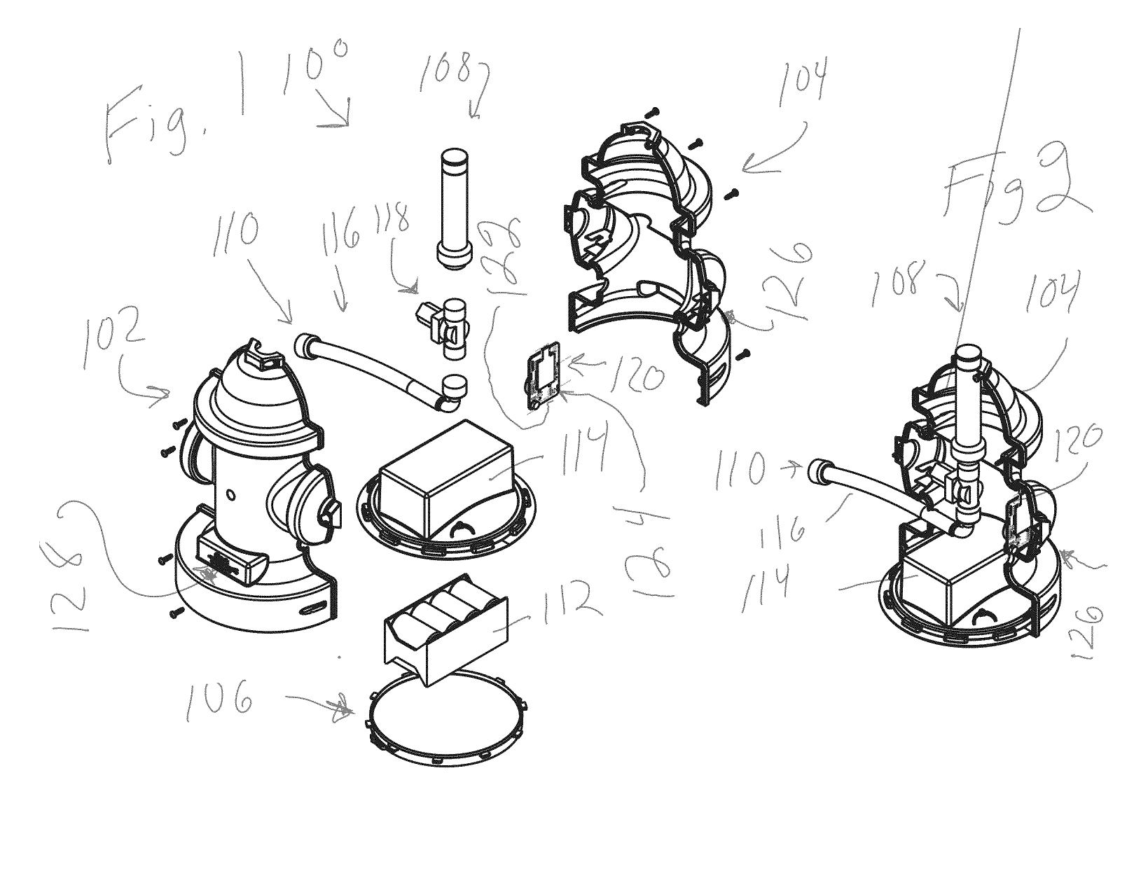

Now referring to the drawings, where like numerals refer to like matter throughout, and more specifically to FIG. 1, there is shown a remotely programmable electronic lawn sprinkler with dog bark activation generally designated 100, having a first half of fire hydrant shaped cover 102, a second half of fire hydrant shaped cover 104, and a bottom of fire hydrant shaped cover 106, which may be made of polypropylene, High Density Polyethylene (HDPE) or other suitable materials.

For some embodiments of the present invention, the visual appearance of remotely programmable electronic lawn sprinkler with dog bark activation 100 being in a shape of a fire hydrant is important because it is believed that dogs who are exposed to fire hydrants, which are accessible by other dogs, will learn to associate the shape of a fire hydrant with a high likelihood of detecting urine from other dogs and thusly may encourage urination at or on fire hydrant shaped objects, even if urine from other dogs is not present.

Sprinkler head 108 is shown as a low noise gear driven sprinkler, but this is just one of several well known types of sprinkler heads which could be used interchangeably. In some embodiments of the present invention, an impact sprinkler head may be preferred. Either of these two mentioned designs are well known to have the ability to adjust the direction and distance of the spray pattern therefrom.

A means for providing pressurized water such as a garden hose female coupler 110 is where water enters remotely programmable electronic lawn sprinkler with dog bark activation 100, and is provided through water intake hose 116 to electronic water control valve 118 and then to sprinkler head 108. In one indoor embodiment, the means for providing pressurized water can have the garden hose female coupler 110 and water intake hose 116 replaced with a spray bottle component that will provide less water volume but a range similar to long range squirt guns. This means for providing pressurized water can be accomplished with a pressurized tank or a high pressure pump. Electronic water control valve 118 receives electronic control signals telling the valve to be open, closed or in some embodiments to be partially opened to allow for regulation of different rates of water to be sprayed. Circuit board 120 provides the electronic control signals to electronic water control valve 118. Note that for clarity of the drawings, the wires connecting all of the electronic components are not shown but they do form a part of the present invention. In some embodiments, wires can extend from all electrical components, 112, 118, and 128 to the circuit board 120, which acts as a hub for all components. In some embodiments, an electronically controlled sprinkler head with remote programmability of direction and distance of spray can be included. In still another embodiment, a means for tracking a dog can be included which can be a wearable clip to allow for directional targeting of a specific dog. In such an embodiment, if the means for tracking loses track of the dog, a warning tone may issue but the activation of electronic water control valve 118 can be disabled until the tracking information is regained. This directional spray control can be accomplished with a means for directionally aiming a water stream, which can be internal to the remotely programmable electronic lawn sprinkler with dog bark activation 100 and integral with the barking sensing function therein or it may be an external device upon which the remotely programmable electronic lawn sprinkler with dog bark activation 100 is placed and rotated therewith. In such embodiments, this means for directionally aiming a water stream will be independent of the internal bark sensing functions of the remotely programmable electronic lawn sprinkler with dog bark activation 100. In these and other embodiments with a more distributed processing or communication scheme, each electronic component may be coupled to every one of the other electronic components. These wires should be deemed by this reference to be shown in the drawings.

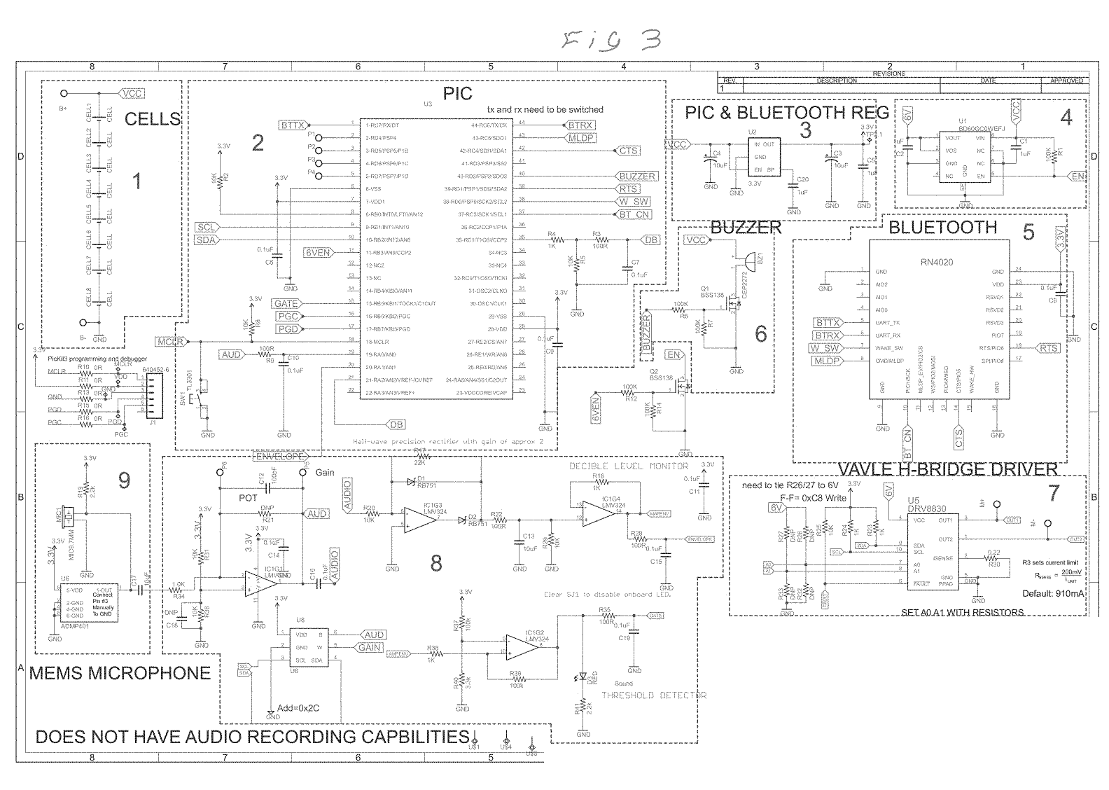

Now referring to FIG. 2, there is shown a partially assembled version of the remotely programmable electronic lawn sprinkler with dog bark activation 100 with the first half of fire hydrant shaped cover 102 not yet having been attached.

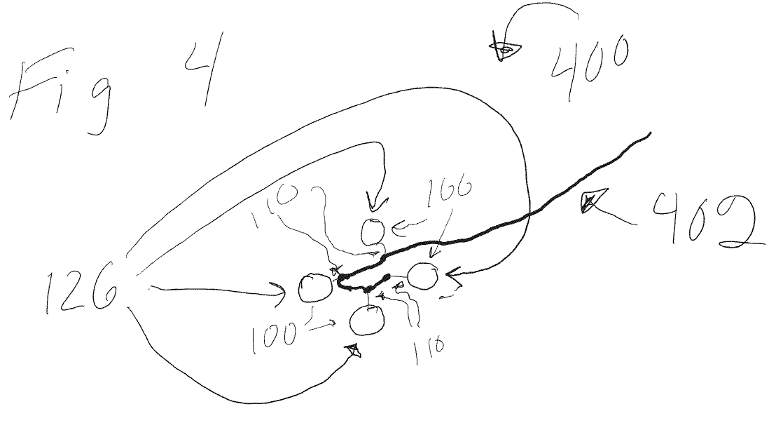

Now referring to FIG. 3, there is shown an electronic schematic diagram of the circuit board 120. Each section of the schematic is labeled with a number 1-9, each of which is described in more detail below:

Section 1: Cells—The power source for the remotely programmable electronic lawn sprinkler with dog bark activation 100. Eight type D alkaline cell are placed in series to provide the remotely programmable electronic lawn sprinkler with dog bark activation 100 with a DC voltage of 8 to 12 V.

Section 2: Microcontroller—The intelligence of the remotely programmable electronic lawn sprinkler with dog bark activation 100, this programed integrated circuit controls all the functions of the unit. In some embodiments, the system could utilize a counter which keeps track of the number of times that the system is activated. Time, date and duration of activation could be recorded as well. In another embodiment, a means for individual bark identification can comprise, the PIC in combination with an associated memory, which is programmed to compare incoming microphone signals to pre-recorded barks (in memory) of a target dog, when sufficient individual voice or bark characteristics match, the activation signal can be generated. This can provide dog specific capabilities. Loud barks from other dogs which are out of the range of the sprinkler head 108 can be ignored. The Sound Hound music identification app is a model for the above described programming.

Section 3: Microcontroller and Bluetooth Regulator—An integrated circuit that controls the voltage to the microcontroller and Bluetooth portions of the remotely programmable electronic lawn sprinkler with dog bark activation 100.

Section 4: A 6 volt regulator circuit for the value control circuitry.

Section 5: Bluetooth module—The wireless communications circuit that allows the remotely programmable electronic lawn sprinkler with dog bark activation 100 to communicate to a smart phone. Note, in some embodiments this section would be capable of communicating with Wi-Fi signals, or with both Wi-Fi and Bluetooth or other suitable wireless communication types.

Section 6: Buzzer—Audible signal from the remotely programmable electronic lawn sprinkler with dog bark activation 100.

Section 7: Valve controller—This integrated circuit that controls the on and off function of the remotely programmable electronic lawn sprinkler with dog bark activation 100 water valve. In some embodiments, the valve could be electronically controlled to different degrees of openness and therefore provide for remote programmability of the pressure and flow rate out of the sprinkler head 108.

Section 8: Audio Amplification—The components of this portion of the remotely programmable electronic lawn sprinkler with dog bark activation 100 circuit condition the audio signal so that it can be interpreted by the microcontroller and used to determine current audio level of the input sensor.

Section 9: Microphone—This is the audio sensor that takes “real world” sound and converts it to an electrical signal that is passed to the amplification stage of the circuit.

### Circuit Overview

The circuit contained within the remotely programmable electronic lawn sprinkler with dog bark activation 100 has a multifunction purpose. The circuit is designed to monitor and pick up ambient noise levels and convert these audio triggers and turn them into electrical signals that are monitored by a microcontroller. The microcontroller will monitor the signal and based on pre-programed detection levels, it will trigger a series of reactions that will control an audible tone as a warning and trigger a water dispensing valve.

The microcontroller is programed with default settings but is connected to a controlling device, such as a smart phone, via a Bluetooth interface. Over this Bluetooth interface, the end user can configure the remotely programmable electronic lawn sprinkler with dog bark activation 100 variables as desired for the particular dog being trained.

It is believed that the understanding of the operation of the present invention is improved by reviewing possible user instructions for the remotely programmable electronic lawn sprinkler with dog bark activation 100. Both the instructions for smart phone users and non-smart phone users is provided. For the smart phone app users, an app would need to be created which provides the functionality as discussed in this application.

### Non Smart Phone Application

1. Remove unit from packaging

2. Insert 8 D Cell Batteries per Diagram

3. Replace battery cover and turn tightly

4. Attach standard garden hose

5. Attach garden hose to water source

6. Direct sprinkler head toward dogs in kennel

7. When three consecutive barks occur, Beeper should sound

8. Unit will listen for 5 seconds
a. If barking occurs within 5 seconds, Beeper will sound and then unit will spray water.
b. If no sound occurs within 5 seconds, Unit will reset and wait for next series of barks, then Beeper only will sound again.
c. This pattern will continue.

### Smart Phone Users

1. Remove unit from packaging

2. Insert 8 D Cell Batteries per Diagram

3. Replace battery cover and turn tightly

4. Attach standard garden hose

5. Attach garden hose to water source

6. Turn on water

7. Direct sprinkler head toward dogs in kennel

8. Go to Google Play Store/Apple Store

9. Download appropriate app

10. Turn on your Bluetooth option on your phone or tablet

11. Open app

12. Scan for local devices

13. a. Select your remotely programmable electronic lawn sprinkler with dog bark activation to connect. (Note: in some embodiments, each circuit board 120 has a unique serial number which is used as an ID in the smart phone app. This is necessary when one phone is used to control multiple remotely programmable electronic lawn sprinklers with dog bark activation.)

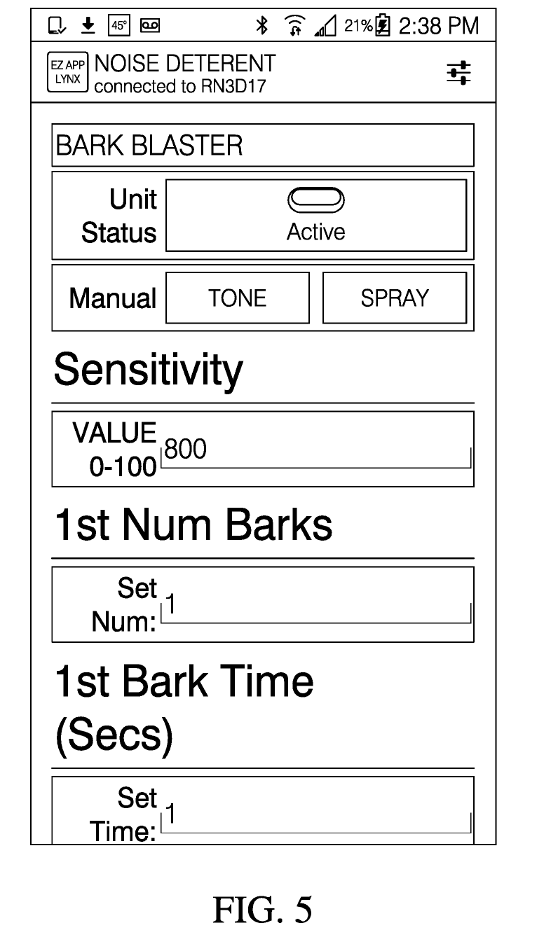

13. b. The screen that you should see is shown in FIG. 5.

14. You can now test the unit by selecting “Tone”

15. You can set the sensitivity of the product. (Lower number=Less responsive, Higher number=More responsive)

16. You can then adjust the other settings to customize for your situation

17. You can then exit the app and it will save your settings until you replace batteries. At that point, you will need to adjust back to your preferred settings.

Using the above instructions for the Smart Phone User, one can set the spray interval to an hour or more (unlimited). When activated, the sprinkler will continue to operate for the selected amount of time and then shut off automatically.

Now referring to FIG. 4, there is shown a directionally responsive bark activated lawn sprinkler system 400 of the present invention which comprises: an array of four remotely programmable electronic lawn sprinklers with dog bark activation 100, disposed around a central location, which location could be, but need not be, a location where high concentrations of dog urine would not pose a problem to a lawn or nearby plants. (Each remotely programmable electronic lawn sprinkler with dog bark activation 100 could be placed in a pan to catch dog urine if it is desired that urine concentrated on the remotely programmable electronic lawn sprinklers with dog bark activation 100 is not acceptable.) In this embodiment, the housing sound transmission zone 126 for each of the remotely programmable electronic lawn sprinklers with dog bark activation 100 is directed radially outward from the central location and each of the garden hose female couplers 110 is directed radially inward. A water distribution system 402 provides water to each of the remotely programmable electronic lawn sprinklers with dog bark activation 100. The water distribution system 402 could be as simple as a series of garden hoses and hose splitters which are well known. In operation, the directionally responsive bark activated lawn sprinkler system 400 could function as follows: if a dog enters the area and approaches one of the remotely programmable electronic lawn sprinklers with dog bark activation 100, and urinates on one of them, the urine is located in an area predetermined to be acceptable for high concentrations of urine, this thereby helps reduce high concentration in other areas where such urine concentrations can be harmful or unpleasant. If the dog remains further away and barks, it will be in a larger surface area and therefore less likely to result in high urine concentrations. As the dog approaches any remotely programmable electronic lawn sprinkler with dog bark activation 100, the area in which urination could occur decreases, thereby resulting in a higher potential for high urine concentrations. However, as the dog approaches the remotely programmable electronic lawn sprinkler with dog bark activation 100, the likelihood of detecting a bark increases and therefore the likelihood that the dog will be sprayed increases and the likelihood of dog movement decreases, which inherently reduces high concentration of urine. In the directionally responsive bark activated lawn sprinkler system 400, it is likely that only one remotely programmable electronic lawn sprinkler with dog bark activation 100 will be triggered and water will be sprayed because the housing sound transmission zone 126 would be optimally directed for only one remotely programmable electronic lawn sprinkler with dog bark activation 100.

It is understood that various changes can be made to the above invention without diverting from the spirit and scope of the present invention. It is the intention of the present invention to include all variations. One specific variation of the invention is that the present invention could not only encourage movement of dogs to minimize high urine concentrations, it could also be utilized to discourage dogs from barking. These and other possible variations are believed to fall within the spirit and scope of the present invention. The above-described embodiments are intended as examples and are not intended to limit the scope of the present invention as described in the claims below.

We claim:

1. A method of encouraging a barking dog to move to a different location and thereby reducing dog urine concentrations in a lawn comprising the steps of:
providing a first remotely programmable electronic lawn sprinkler, having:
a first portable cover 102, 104, sized and configured to be carried by a person and placed at variable locations;
a first garden hose female coupler 110 disposed on a first back side of said first cover;
a first housing sound transmission zone 126, located at a first front side of said first cover;
a first sprinkler head 108, disposed on said first cover;
a first electronic water control valve 118 disposed inside said first cover;
a first microphone 122, disposed inside said first cover and disposed in registration with said first housing sound transmission zone 126, so as to directionally discriminate from detection by said first microphone, sound waves, which are more obliquely incident on a first surface of said first cover, immediately around said first housing sound inlet port, than are sound waves which are more orthogonal to said first surface of said first cover immediately around said first housing sound inlet port;
a first battery 112 disposed inside said first cover; and
a first circuit board 120 disposed inside said first cover which has:
a first microcontroller section 3 configured to: receive electric power from said first first battery; receive electronic signals originating from said first microphone which are representative of sound originating from outside said first cover; and generate first electronic control signals for use in control of said first electronic water control valve; and
a first section 5 configured to receive, from a remote appliance, wireless signals for remote programming of said first microcontroller section so as to set:
a. a sensitivity characteristic representative of a minimum threshold under which sound will not be recognized as a sound event;
b. a minimum number of sound events needed to trigger generation of one of said electronic control signals;
c. receiving from said remote appliance said wireless signals; and
d. configuring said first microcontroller section to be responsive to said wireless signals, by changing:
a. a sensitivity characteristic representative of a minimum threshold under which sound will not be recognized as a sound event;
b. a minimum number of sound events needed to trigger generation of one of said electronic control signals;
c. said first front side and said first back side being disposed on opposite sides of said first cover, so that a direction of water inlet into said first cover is substantially opposite of a direction of least discrimination of sound waves incident upon said first microphone;
d. receiving electronic signals from said first microphone representative of said minimum number of sound events; and
e. generating an electronic control signal for said first electronic water control valve commanding the valve to open and to spray water out of said sprinkler head, in response to said electronic signals from said first microphone representative of said minimum number of sound events.

2. The method of claim 1 wherein said minimum number of sound events occurred during a time interval as set by the remote appliance.

3. The method of claim 1 wherein: said first cover is formed in a shape of a fire hydrant.

4. The method of claim 1 wherein said sound event is a bark of a dog.

5. The method of claim 1 wherein said remote appliance is a smart phone.

6. The method of claim 1 wherein said wireless signals are Bluetooth signals.

7. The method of claim 1 wherein said electronic control signal for said first electronic water control valve commanding the valve to open is a command to open to an intermediate opening which provides for less waterflow than if the valve were fully opened.

8. The method of claim 7 wherein said command to open to an intermediate opening corresponds to a determination by said microcontroller section that the last sound event had a higher volume level than at least one of the other sound events, constituting said minimum number of sound events.

9. The method of claim 7 wherein a downward spray direction sprinkle control command is issued which corresponds to a determination by said microcontroller section that the last sound event had a higher volume level than at least one of the other sound events, constituting said minimum number of sound events.

10. The method of claim 9 wherein a command to open to an intermediate opening corresponds to a determination by said microcontroller section that the last sound event had a higher volume level than at least one of the other sound events constituting said minimum number of sound events.

11. A system for reducing dog urine concentrations in a lawn comprising:
a first remotely programmable electronic lawn sprinkler, having:
a first portable cover 102, 104, sized and configured to be carried by a person and placed at variable locations;
a first garden hose female coupler 110 disposed on a first back side of said first cover;
a first housing sound transmission zone 126, located at a first front side of said first cover;
a first sprinkler head 108, disposed on said first cover;
a first electronic water control valve 118 disposed inside said first cover;
a first microphone 122, disposed inside said first cover and disposed in registration with said first housing sound transmission zone 126, so as to directionally discriminate from detection by said first microphone, sound waves which are more obliquely incident on a first surface of said first cover, immediately around said first housing sound inlet port, than are sound waves which are more orthogonal to said first surface of said first cover immediately around said first housing sound inlet port;
a first battery 112 disposed inside said first cover; and
a first circuit board 120 disposed inside said first cover which has:
a first microcontroller section 3 configured to: receive electric power from said first battery, receive electronic signals originating from said first microphone, which are representative of sound originating from outside said first cover, and generate first electronic control signals for use in control of said first electronic water control valve; and
a first section 5 configured to receive, from a remote appliance, wireless signals for remote programming of said first microcontroller section so as to set:
a. a sensitivity characteristic representative of a minimum threshold under which sound will not be recognized as a sound event;
b. a minimum number of sound events needed to trigger generation of one of said electronic control signals; and
c. said first microcontroller section being configured to be responsive to said wireless signals, by changing:
a. a sensitivity characteristic representative of a minimum threshold under which sound will not be recognized as a sound event;
b. a minimum number of sound events needed to trigger generation of one of said electronic control signals; and
c. said first front side and said first back side being disposed on opposite sides of said first cover, so that a direction of water inlet into said first cover is substantially opposite of a direction of least discrimination of sound waves incident upon said first microphone.

12. A system of claim 11 further comprising:
a second remotely programmable electronic lawn sprinkler, having:
a second portable cover 102, 104, sized and configured to be carried by a person and placed at variable locations;
a second garden hose female coupler 110 disposed on a second back side of said second cover;
a second housing sound transmission zone 126, located at a second front side of said second cover;
a second sprinkler head 108, disposed on said second cover;
a second electronic water control valve 118 disposed inside said second cover;
a second microphone 122, disposed inside said second cover and disposed in registration with said second housing sound transmission zone 126, so as to directionally discriminate from detection by said second microphone, sound waves which are more obliquely incident on a second surface of said second cover immediately around said second housing sound inlet port, than are sound waves which are more orthogonal to said second surface of said second cover immediately around said second housing sound inlet port;
a second battery 112 disposed inside said second cover; and
a second circuit board 120 disposed inside said second cover which has:
a second microcontroller section 3 configured to: receive electric power from said second battery, receive electronic signals originating from said second microphone, which are representative of sound originating from outside said second cover; and generate second electronic control signals for use in control of said second electronic water control valve;
a second section 5 configured to receive, from a remote appliance, wireless signals for remote programming of said second microcontroller section so as to set:
a. a sensitivity characteristic representative of a minimum threshold under which sound will not be recognized as a sound event;
b. a minimum number of sound events needed to trigger generation of one of said electronic control signals; and
c. said second microcontroller section being configured to be responsive to said wireless signals, by changing:
a. a sensitivity characteristic representative of a minimum threshold under which sound will not be recognized as a sound event;
b. a minimum number of sound events needed to trigger generation of one of said electronic control signals; and,
c. said second front side and said second back side being disposed on opposite sides of said second cover, so that a direction of water inlet into said second cover is substantially opposite of a direction of least discrimination of sound waves incident upon said second microphone.

13. A system of claim 11 wherein: said first cover is formed in a shape of a fire hydrant.

14. A system of claim 11 wherein said sound event is a bark of a dog identified with a means for individual bark identification.

15. A system of claim 11 wherein said remote appliance is a smart phone.

16. A system of claim 11 wherein said wireless signals are Bluetooth signals.

17. The method of claim 1 wherein said wireless signals are Wi-Fi signals.

18. The system of claim 11 wherein said wireless signals are Wi-Fi signals.

19. The system of claim 11 further comprising:
a means for tracking a dog; and
a means for directionally aiming a water stream which is responsive to said means for tracking a dog.

20. The system of claim 11 wherein the garden hose female coupler 110 and water intake hose 116 are replaced with alternate means for providing pressurized water comprising a spray bottle component.
